(19) United States
(12) Patent Application Publication
(10) Pub. No.: US 2017/0314526 A1
(43) Pub. Date: Nov. 2, 2017

(54) WAVE POWER CONVERTER

(71) Applicant: Francis James MacDonald FARLEY, Alpes Maritimes (FR)

(72) Inventor: Francis James MacDonald FARLEY, Alpes Maritimes (FR)

(21) Appl. No.: 15/525,395

(22) PCT Filed: Nov. 6, 2015
(86) PCT No.: PCT/GB2015/053377

§ 371 Date: May 9, 2017

(30) Foreign Application Priority Data
Nov. 9, 2014 (GB) 1419919.4

(51) Int. Cl. F03B 13/24; F03B 13/18

(52) U.S. Cl. CPC F03B 13/24; F03B 13/188; F05B 2270/18; F05B 2220/706

(57) ABSTRACT

A wave power converter is presented comprising an airtight compressible bag supporting a ballast and configured to be inflated with gas. The airtight compressible bag comprises flexible walls, wherein the shape and length of the bag is determined by the equilibrium between the weight of the ballast and the pressure inside the bag. A floating body is connected to the airtight compressible bag by a tube. The converter comprises one or more airtight vessels and a power conversion means for generating power from the reciprocating flow of gas between the bag and airtight vessel. The airtight compressible bag is submerged and surrounded by water on all sides wherein the heaving and/or pitching of said floating body excites the oscillation of said ballast which squeezes and expands said airtight compressible bag driving the contained gas via the tube and power conversion means into and out of the airtight vessel.

### FIELD OF THE INVENTION

The present invention is in the field of power generation, in particular devices that convert wave power into electrical power.

### BACKGROUND

Wave power converters, also known as wave energy converters, are known to convert wave energy into useful energy such as electrical energy. When operated in the open sea, devices move in response to the waves. One problem faced in the design of wave energy converters is how to convert this motion into useful power when no stationary reference is available. Some existing converters are attached to the sea floor whilst some use an auxiliary mass which moves differently.

Patent document GB2488185 describes a free floating bellows wave energy converter. The main vessel has side walls that are supported by rigid cover plates or rigid rods.

Patent document GB2472055 describes a dual bellows pneumatic wave energy device having an oscillating frame connected to a weight and coupled to a float via tether strings.

Neither of these documents describes a converter that operates to extract energy arising from the heaving and pitching motion of a float.

### SUMMARY

There is presented herein, a wave power converter for generating electrical power from water waves; the wave power converter comprising: an airtight compressible bag supporting a ballast and configured to be inflated with gas; the airtight compressible bag comprises flexible walls, wherein the shape and length of the bag is determined by the equilibrium between the weight of the ballast and the pressure inside the bag; a floating body connected to the airtight compressible bag by a tube; and, an airtight vessel; and, a power conversion means configured to generate power from the reciprocating flow of gas between said airtight compressible bag and said airtight vessel; the wave power converter is configured such that, in use, the airtight compressible bag is totally submerged and surrounded by water on all sides wherein the heaving and/or pitching of said floating body in response to the waves excites the oscillation of said ballast which squeezes and expands said airtight compressible bag driving the contained gas via the tube and power conversion means into and out of the airtight vessel.

The wave power converter may be modified in any suitable way as disclosed herein including but not limited to any one or more of the following.

The wave power converter may be configured such that said airtight compressible bag is comprised of any one or more of: rubber sheet, synthetic polymer or polymer coated fabric, reinforced with fibres, cables, strings or tendons.

The wave power converter may be configured such that the airtight compressible bag comprises a fabric and wherein the shape and vertical length of the bag is a function of the tension in the fabric and the gas pressure inside.

The wave power converter may be configured such that the fabric of the bag is sufficiently flexible or elastic in the horizontal direction to stretch or fold as the bag expands and contracts.

The wave power converter may be configured such that the airtight compressible bag is substantially axisymmetric about a vertical axis extending through opposite ends of the bag connecting the tube and ballast.

The wave power converter may be configured such that the floating body comprises an elongate in plan shape.

The wave power converter may be configured such that the airtight compressible bag is located about an off centre position along the elongate length of the floating body.

The wave power converter may be configured such that the power conversion means comprises a housing suspended from an axle that is substantially horizontal and parallel to the elongate length of the float.

The wave power converter may be configured such that the floating body comprises at least one or more float ballast containers located about one or both of the bow and stern of the floating body; the said containers configured to hold fluid.

The wave power converter may be configured such that the floating body comprises a further float ballast container located about the centre of the elongate length, the wave power converter further comprising a pumping device configured to pump liquid to and from the centre container to at least one of the said one or more ballast containers.

The wave power converter may be configured such that the power conversion means comprises a reversible flow air turbine.

The wave power converter may be configured such that the said ballast is suspended from an end portion of the bag directly opposite the end of the bag connected to the said tube.

The wave power converter may be configured such that the airtight vessel comprises one or more elastic walls made of rubber or synthetic polymer with the effect that it is distensible.

The wave power converter may comprise an elongate float connected to two compressible bags located below it, each furnished with ballast weights and separate power conversion means, said compressible bags communicating via a tube which allows gas to flow from one compressible bag to the other and to said airtight vessel.

The wave power converter may comprise four of the said floating bodies and four of the said airtight compressible bags, each bag supporting a separate ballast and fluidly connected to a separate power conversion means, the said bags communicating via tubes to allow gas to flow from one compressible bag to another and to said airtight vessel.

The wave power converter may further comprise a flexible or distensible bag entirely under water containing a variable quantity of water and mechanically attached to the float.

The wave power converter may be configured such that the float comprises an airtight fabric inflated with gas under pressure and configured to be deflated to allow the converter to sink until the ballast weights touch the sea bed.

The wave power converter may further comprise reflation means for inflating the float.

The wave power converter may be configured such that the reflation means comprises a pump aspirating air from the atmosphere through a snorkel or gas bottles carried on the float.

The wave power converter may be configured such that the tube connecting the airtight compressible bag to the floating body maintains a substantially vertical orientation when the floating body pitches and/or rolls.

### BRIEF DESCRIPTION OF THE DRAWINGS

Some specific embodiments of the invention will now be described by way of example without limitation with reference to the accompanying drawings in which:

FIG. 1 shows, in side elevation and in lateral cross section, an example of a wave power converter comprising a float with a single submerged compressible bag;

FIG. 2 shows, in side elevation and in lateral cross section, an example of a wave power converter comprising an elongate float with two submerged compressible bags;

FIG. 3A shows, in plan, an example of a wave power converter comprising four floats with four submerged compressible bags;

FIG. 3B shows, in elevation, the cross section of the wave power converter shown in FIG. 3A along the line A-A;

FIG. 4 shows an example of a wave power converter comprising an elongate float with a single submerged compressible bag;

FIG. 5a shows a plan view of an example of a turbine with connecting pipes;

FIG. 5b shows, in elevation, a cross section of the turbine of FIG. 5a along the line A-A;

FIG. 5c shows, in elevation, a cross section of the turbine of FIG. 5b along the line B-B;

FIG. 6a shows a plan view of an example of a wave power converter having an elongate floating body and a single airtight compressible bag;

FIG. 6b shows a side view of the wave power converter of FIG. 6a.

### DETAILED DESCRIPTION

There is presented herein a wave power converter for generating electrical power from water waves. The wave power converter comprises an airtight compressible bag supporting a ballast (also referred to as a ‘ballast weight’) and configured to be inflated with gas. The airtight compressible bag comprises flexible walls, wherein the shape and length of the bag is determined by the equilibrium between the weight of the ballast and the pressure inside the bag. The wave power converter further comprises a floating body connected to the airtight compressible bag by a tube. The wave power converter comprises one or more airtight vessels and a power conversion means configured to generate power from the reciprocating flow of gas between said bag and said airtight vessel. The wave power converter is configured such that, in use, the airtight compressible bag is totally submerged and surrounded by water on all sides wherein the heaving and/or pitching of said floating body in response to the waves excites the oscillation of said ballast which squeezes and expands said airtight compressible bag driving the contained gas via the tube and power conversion means into and out of the airtight vessel.

The wave energy converter may be incorporated into a heaving or pitching wave power machine. The energy converter converts the motion into a pneumatic flow of gas through a turbine without using any external reference.

The converter provides a system for converting the vertical motion of a body in waves into useful power. Such power may be any type of power including pneumatic or electrical. There is further provided heaving and pitching wave power converters incorporating the system.

The wave power converter presented herein comprises a submerged compressible airtight bag inflated with air or other gas under pressure. To be compressible, said bag may have elastic walls made of rubber or synthetic polymer or it may have vertically pleated walls made of flexible airtight fabric. Said compressible bag is not located on the sea bed nor mounted on any fixed structure. By being submerged in use, it is surrounded by water on all sides. The sides of the bag are preferably not attached to any other body or structure. The bag may be axisymmetric about a vertical axis. That is, the bag may possess rotational symmetry about the vertical axis wherein the vertical axis passes through the ends of the bag. The horizontal cross section of the bag (i.e. in a plane perpendicularly intersecting the vertical axis) may, however, vary in diameter about different positions along the vertical axis from one bag end to another bag end.

The ends of the bag along this vertical axis are preferably attached to one of the connecting tube and ballast. The bag preferably has continuous and substantially smooth curved sidewalls extending from one bag end to another wherein the sidewalls preferably curve outwardly towards an intermediate point and then inwardly towards the opposite end. The bag may therefore be streamlined to allow it to move through the water and minimise the amount of turbulence.

The bag experiences downward force by having a ballast weight attached to its lowest point. Said ballast weight preferably approximately matches the up-thrust on the bag due to its displacement with the effect that the combination is roughly in vertical equilibrium. A tube (referred to below as the “connecting tube”) is attached more or less (substantially) centrally to the top of the bag and is mechanically attached to the floating body above it.

The bag may have flexible walls wherein the shape and vertical length of the bag is a function of the tension in the fabric and the gas pressure inside. Said shape and length is determined by the equilibrium between the weight of the ballast which tends to stretch the bag reducing its volume and the pressure inside which tends to widen the bag, increasing its volume and lifting the ballast. If the top of the bag has a fixed vertical position, the ballast can oscillate vertically about its equilibrium position. The period of said oscillation is determined by the mass of the ballast, the volume of the bag and the gas pressure inside. With advantage said oscillation period is chosen to match the period of the waves in the sea.

The top of the bag is preferably connected via said connecting tube to the floating body above it (also referred to herein as “the float”) which heaves or pitches in response to the waves. This vertical motion is communicated to the top of the bag and excites an amplified vertical oscillation of the ballast. The amplitude of the ballast motion can be many times the amplitude of the waves in the sea.

Gas from the bag can pass through said connecting tube into and out of a second vessel associated with the floating body (also referred to herein as the airtight vessel).

En-route it passes through a power conversion means. The power conversion means is any means for converting a flow of gas into useful energy. With advantage said power conversion means and said second vessel may be mounted on or incorporated in the float. Said second vessel and power conversion means are filled with the same gas at the same pressure as the compressible bag. Said second vessel may be of fixed volume or may have one or more elastic walls with the effect that it is distensible. It is not exposed to the waves of the sea.

As the ballast oscillates said compressible underwater bag is alternately squeezed and expanded, so the gas pressure inside changes and the contained gas is driven to and fro via the power conversion means into and out of said second vessel. The gas flow through the power conversion means generates useful power according to the art.

The power conversion means may be a reversible flow air turbine for example a Wells turbine which rotates in the same direction whichever way the gas is flowing through it. The turbine generates electricity according to the art or any other form of useful power which may be transmitted to shore or used on board.

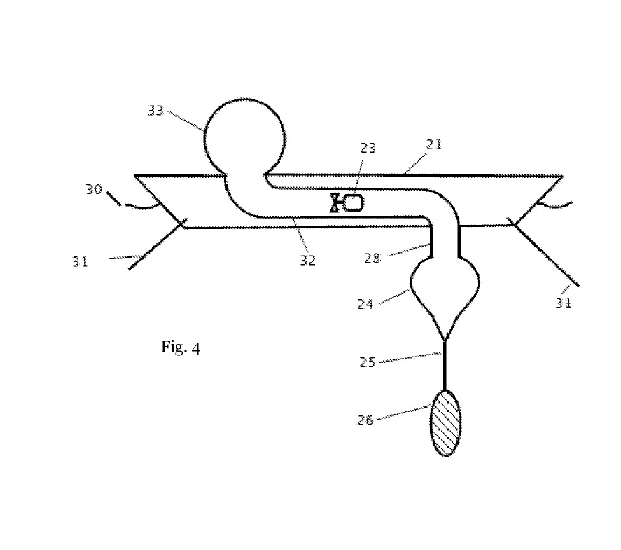

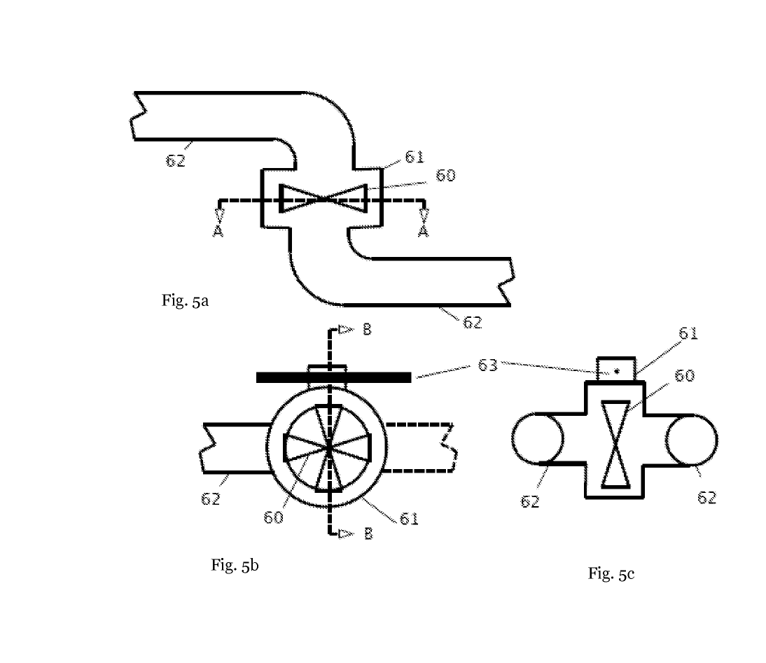

In some examples, as described elsewhere in this application, the float may comprise an elongate in-plan shape. The turbine 23 may be mounted with its axis of rotation parallel to the long axis of the float as shown in FIG. 4. Alternatively to minimise gyroscopic forces from the movement of the float, the turbine 23 may be mounted with its plane of rotation vertical and parallel to the elongate length of the float, as shown in FIG. 5a, wherein the elongate length/axis of the float is parallel to the line A-A.

FIG. 5a shows the turbine blades 60 in the housing 61 with tubes 62 connecting on one side to said airtight compressible bag and on the other side to said second (airtight) vessel. The pitching of the float (not shown in FIGS. 5a-c) is then in the same plane as the turbine blades, so no gyroscopic forces are generated. As shown in FIGS. 5b and 5c, the housing 61 of the turbine 60 may be suspended from an axle 63 which is horizontal and parallel to the long axis of the float (i.e. parallel to the line A-A in FIG. 5a), with the effect that if the float rolls, the turbine 6o remains in the vertical plane, so no gyroscopic forces are generated either by pitch or roll. In this case the tubes 62 bringing air to and from the turbine must be provided with sufficient compliance to allow the housing 61 to rotate relative to the float about the axle 63, for example being provided with one or more sections that can deform to accommodate the new component orientations but still allow for gas to pass through. An example of such a tube section could be a tube formed of rubber.

These turbine mounting features described above may equally be used on wave power converters that do not have an elongate shape wherein the wave power converter is configured to align one of its dimensions parallel with the direction of the waves. In this circumstance, the axle 63 is horizontal and parallel to the axis of the float parallel with the direction of the waves.

A plurality of compressible bags communicating with each other and with said second vessel may with advantage be attached to a single float and generate useful power from the flow of gas between said vessels generally as already described.

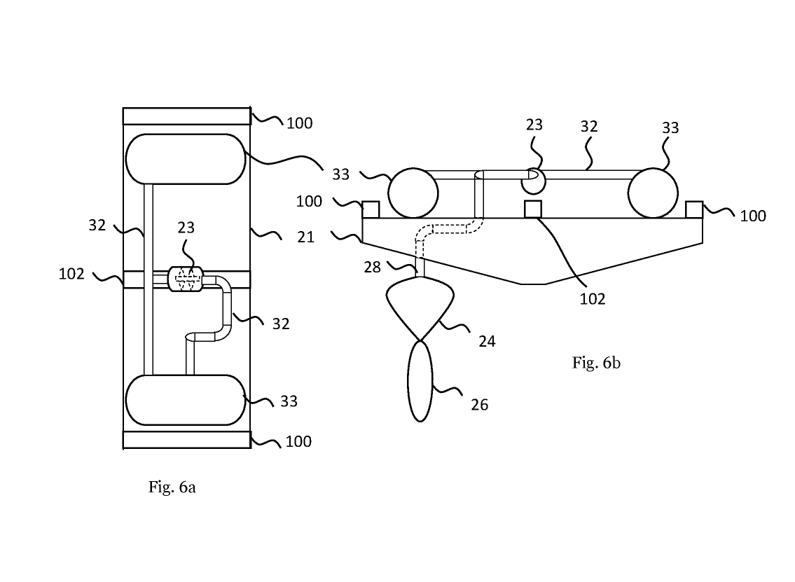

The airtight vessel may be any suitable vessel and may comprise one or more airtight vessels. For example, the power conversion means may be fluidly connected to two or more airtight vessels as shown in FIGS. 6a/6b. The fluid connection between the power conversion means and the airtight vessels is preferably using airtight tubes that a configured to transfer gas from the one or more vessels to the power conversion means. Similar tubes may also be used for fluidly connecting the one or more airtight compressible bags to the power conversion means. The tubes may be substantially rigid and have a fixed positional relationship with respect to other components of the wave energy converter. In some examples, at least a portion of the tubes may be moveable or reconfigurable such that relative movement of different components of the wave energy converter (for example the power conversion means and the airtight vessel) may be accommodated for. The airtight vessel and tubes (including the connecting tube and further tubes carrying gas between the turbine, bag and airtight vessels) may be formed from any suitable material including, but not limited to, any one or more of metals, plastics, fabrics and polymer coated fabrics. In some examples the airtight vessels associated with the floating body may have a rigid shape. In some examples the airtight vessels may be distensible.

Components such as the tubes and airtight vessels may be formed from rigid materials such as, but not limited to, high-density polyethylene (HDPE).

Any of the airtight vessels and/or connecting tubes and/or the power conversion means may be integrated upon or within the floating body.

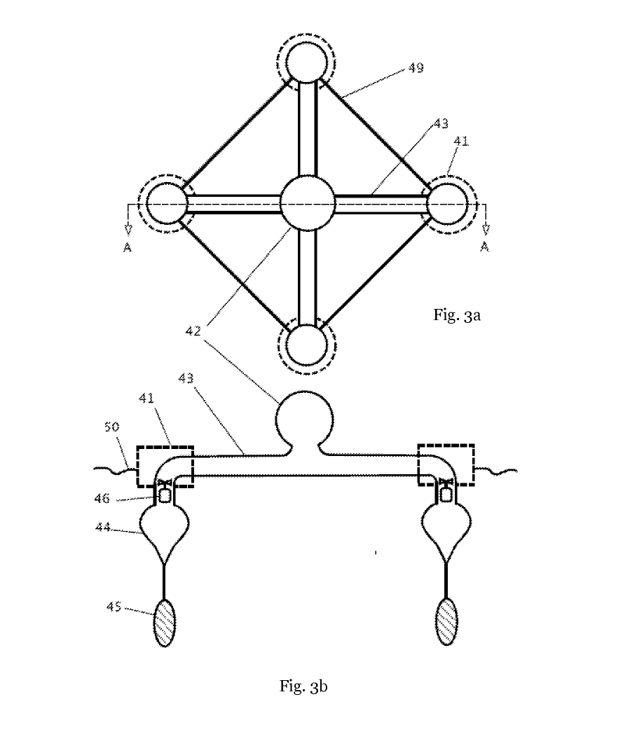

The float may be any shape of size. More than one float may be associated with the wave power converter. Any of the airtight vessel and power conversion means may be housed, mounted upon or accommodate by the float, for example as shown in FIGS. 6a/6b. Alternatively the airtight vessel and power conversion means may not be housed, mounted upon or accommodate by the float but be connected to them, for example in FIG. 3b where the airtight vessel 42 is located separately from the floats 41.

In some examples the length of the float may be between ¼ to ½ wavelength of the average water waves. Preferred length ranges could be between 30-50 m, more preferably 35-45 m. The width of the floating body may be between 5-25 m, more preferably between 10-20 m.

In some examples, the shape of the float may be substantially elongate. The floating body preferably comprises a hull configured to allow the floating body to float on the water and provide a deck portion that nominally resides proud of the waterline. In some examples the shape of the hull may be similar to that of a catamaran having two parallel hulls for low-drag.

The wave power converter may be moored or tethered using any suitable arrangement. A plurality of wave power converters may be moored to form a wave power converter system or network.

In some examples, the wave power converter may comprise one or a plurality of submerged compressible airtight bags, made of flexible airtight fabric, rubber or polymer sheet. Each bag is surrounded by water on all sides and furnished with a ballast weight. The ballast weight (also referred to herein as a ‘ballast’) may be formed from any suitable material and may be connected to the bag either directly or via a connecting member such as a string. In use, the ballast weight resides below the bag in the water.

The wave power converter further comprises a connecting tube connecting each bag via power conversion means to a second vessel not exposed to the waves of the sea. The bag and its connected ballast are therefore free to move within the water about the connection of the bag with the connecting tube. The bag has no other connections (i.e. is unconnected) to other parts of the wave energy converter, apart from its connections with the connecting tube and the ballast. The bag has no lateral connections to any other components of the wave energy converter. The bag has no lateral connections to any fixed position objects or features external from the wave energy converter.

The wave energy converter is preferably configured such that the floating body may move relative to the connecting tube if the floating body pitches and rolls, but substantially maintains its vertical position with the connecting tube if the floating body moves in the vertical dimension, for example if the floating body heaves. In other words, the connecting tube may keep a substantially vertical elongate orientation if the floating body pitches and rolls. This may be accomplished in any suitable way, for example: by having a rotatable joint affixing the connecting tube to further gas carrying tubes within the floating body. Additionally or alternatively, at least a portion of the connecting tube may be flexible, for example being formed from a rubber material.

The whole system is sealed and filled with gas under pressure. Each compressible bag is mounted below the floating body (the float) which heaves or pitches in response to the waves. The vertical motion of the float excites a vertical oscillation of the ballast weight which drives gas to and from via power conversion means between said bags and into and out of said second vessel, generating useful power. With advantage said power conversion means is a reversible flow air turbine, for example a Wells turbine.

The wave power converter may further comprise one or more flexible or distensible vessels located entirely under water and attached to the float. Said flexible or distensible vessel may contain a variable quantity of water. Adding water to said vessel does not change the buoyancy of the system but does increase its inertia and therefore lengthens the resonance period of the device in heave or pitch. This allows the system to be adjusted to match the prevailing waves in the sea.

In some examples, some components of the wave power converter may not be made of rigid materials but may have walls made of flexible airtight fabric, for example without limitation polymer coated fabric, and are inflated with gas under pressure. This may apply in particular to the float, the compressible bag, the connecting tube/s and said second vessel (also referred to as the airtight vessel).

A particular advantage of this construction is that many components can be deflated in storms with the effect that the device sinks below the water surface to a level at which the wave and wind energy are reduced. It may be arranged that the device sinks until said ballast weight reaches the sea bed. Residual buoyancy keeps the device off the sea bed and protected from damage. The mooring system is adapted to permit sinking. When the storm has passed, the pneumatic components may be reflated with reflation means such as air aspirated through a snorkel using power from the shore or with gas from compressed gas containers. The device is completely sealed and not open to the atmosphere, so no water can enter when the machine is submerged.

Particular embodiments of the invention will now be described with reference to the figures. The features, configurations and components of each of these examples may be combined with other examples described herein.

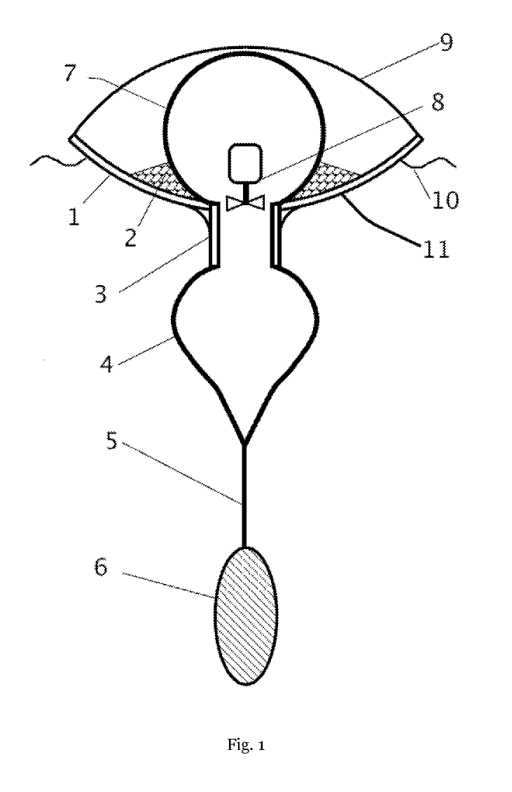

FIG. 1 illustrates by way of example in side elevation a wave power converter. It comprises a float 1 floating in the sea with the waterline indicated by the line 10. Said float is generally wide in horizontal extent but of shallow draft with substantially clear space underneath for water to circulate.

It contains ballast 2, floats freely in the sea without other support and may be located by anchors according to the art. The float supports the connecting tube 3 which is attached to the top of the compressible bag 4. A wire or cable 5 from the bottom of said bag supports the ballast weight 6. The second vessel 7 is located on or inside the float. One or more walls may be elastic with the effect that said vessel is distensible. It communicates with the compressible bag 4 via the connecting tube 3. It is inflated with the same gas at the same pressure as the gas in the compressible bag 4. When the device heaves in response to the waves the reversible flow turbine 8 is actuated by the flow of gas to and fro between the compressible bag 4 and the second vessel 7. The float is sealed with a cover 9. In a preferred embodiment the whole interior of the float with its cover 9 is used as the second vessel; in this case no separate vessel 7 is required. A multiplicity of cables 11 may be used to anchor the system according to the art. The turbine 8 may generate any form of useful power, for example without limitation electricity used on board or transmitted to shore, compressed air or high pressure hydraulic fluid.

The airtight compressible bag 4 may be made of elastic polymer or vertically pleated flexible fabric. It must be strong enough in the vertical direction to support the ballast weight and may therefore be reinforced with a multiplicity of embedded fibres, cables, strings or tendons made of any material. In the horizontal direction the fabric must be sufficiently flexible or elastic to stretch or fold as the bag expands and contracts.

The walls of the float 1 may be rigid or may with advantage comprise inflated fabric which assumes the correct shape when inflated with air under pressure. With advantage said fabric may be elastic. In storms the float may be deflated so that its buoyancy is reduced with the effect that the converter sinks until the ballast weight 6 rests on the sea bed. The residual buoyancy keeps the rest of the converter off the sea bed to avoid damage. When the storm has passed the pneumatic components are reflated with air by reflation means for example by pumping in air through a snorkel (not illustrated) or with gas from compressed gas containers and normal operation resumes.

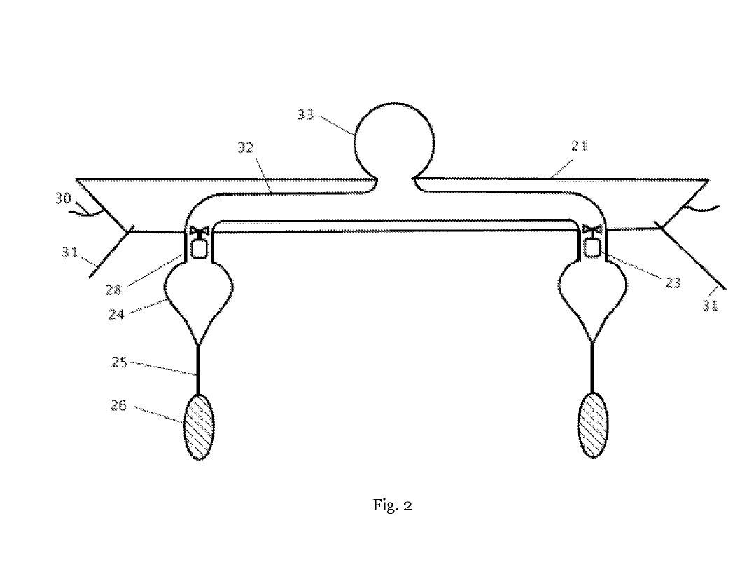

FIG. 2 illustrates by way of example in side section elevation an elongate wave power converter. It comprises an elongate float 21 floating in the sea with the waterline indicated by the line 30. It floats freely in the sea without other support and may be located by anchor cables 31 according to the art. Two compressible bags 24 each substantially as already described are attached to the float complete with individual connecting tubes 28 and ballast weights 26 supported by cables 25. Each bag is furnished with its own reversible flow turbine 23. The contained gas can pass from one compressible bag to the other via the tube 32, which in this example is located inside the float 21 (the tube may be accommodated elsewhere about the float, for example on the top deck). The gas can also pass to the second vessel 33 located in or above the float.

In waves the float can pitch and heave. If the float pitches the ballast weights oscillate vertically in opposite phase with the effect that one compressible bag 24 is compressed while the other expands, so gas is driven to and fro between said compressible bags along the tube 32. Each turbine 23 is driven by said flow. If instead the float heaves both bags 24 are compressed together and the gas flows from the tube 32 into and out of the secondary vessel 33. Again both turbines are actuated. If the float heaves and pitches both processes operate together.

It is well known in the art that a heaving float (as illustrated in FIG. 1) can have a maximum capture width of λ/2 π where λ is the wavelength of the incoming waves. If however the float pitches the capture width rises to 2×λ/2 π. With a combination of heave and pitch in the correct proportions the capture width can rise to 3×λ/2 π.

In the wave power converter illustrated in FIG. 2 the relative contributions of heave and pitch can be adjusted in the design phase by moving the compressible bags 24 closer together or further apart. If the bags are close together the machine responds to heave only. The further they are apart, the greater is the response to pitch. The machine of FIG. 2 can therefore give three times as much power as the machine illustrated in FIG. 1.

The walls of the float 21 may be rigid or may with advantage comprise inflated fabric which assumes the correct shape when inflated with air under pressure. In storms the float may be deflated so that its buoyancy is reduced with the effect that the converter sinks until the ballast weights 26 rests on the sea bed. The residual buoyancy keeps the rest of the converter off the sea bed to avoid damage. When the storm has passed the pneumatic components are reflated with air by reflation means for example by pumping in air through a snorkel, not illustrated, and normal operation resumes.

FIGS. 3a and 3b illustrates by way of example in plan and in side elevation another wave power converter. This wave power converter comprises four floats 41 (shown with dotted lines) mechanically connected by tubes 43 and bracing struts 49. Said tubes and struts are with advantage flexible and elastic with the effect that the structure can yield to the wave forces but retain its general shape as illustrated. Each float 41 supports a compressible bag 44 with ballast weights 45 and reversible flow turbine 46 substantially as already described. The gas contained in the compressible bags can flow between the bags and into and out of the central auxiliary vessel 42 (airtight vessel) via the tubes 43. The structure floats in the sea without other support with the water line indicated by the line 50. The system may be anchored according to the art by cables, not illustrated.

This structure can heave and pitch in resonance with waves coming from any direction. As already described this results in amplified vertical oscillations of the ballast weights 45, compression of the bags 44 and flow through the turbines 46 generating useful energy. This system comprising four compressible bags is equivalent to two of the pitching machines illustrated in FIG. 2, located side by side. Therefore in the optimum case it can capture twice as much power as FIG. 2, that is six times as much power as the single heaving float of FIG. 1.

Substantially as already described the floats 41 may be made of inflated fabric and may be deflated in storms with the effect that the converter sinks until the ballast weights rest on the sea bed. The converter can be reflated later by reflation means as already described.

FIG. 4 shows an example of a wave power converter, similar to FIG. 2 where like components are shown with like references. In this example a single bag 24 is used with the elongate float. The airtight compressible bag is located about an off centre position along the elongate length of the floating body.

FIGS. 6a and 6b show an example of a wave power converter similar to FIGS. 2 and 4 where like reference numerals represent like components. In this example the float 21 comprises an elongate in-plan shape. The airtight compressible bag 24 is located about an off centre position along the elongate length of the floating body.

The floating body 21 comprises one or more float ballast containers 100 located about at least one of the bow and stern of the floating body 21, preferably a container 100 located at the bow and another container located at the stern. The said containers 100 configured to hold fluid. The floating body 21 comprises a further float ballast container 102 located about the centre of the elongate length. The wave power converter further is comprising a fluid pumping device and connecting tubes (not shown in the figures) for pumping liquid (such as water) to and from the centre container to at least one of the said one or more ballast containers. By being able to pump ballast weight, in the form of liquid, to and from the bow/stern containers 100, the wave power converter can tune the pitching motion of the float to the waves so that the wave power converter can achieve a resonance condition and optimally extract power from the waves.

In the example shown in FIGS. 6a and 6b, float ballast containers 100 are provided at both the bow and stern of the float. They may be provided upon the top deck of the floating body or housed within the floating body. The fluid pumping device may be located within the floating body or upon its top deck. In one example the turbine body may be suspended from an axle as described elsewhere in this application.

The following features 1 to 10 are optional features of the invention, any one or more of which may be combined with any of the examples described elsewhere in this application:
Feature 1) A wave power converter comprising a submerged compressible airtight bag inflated with gas under pressure, surrounded by water on all sides not on the seabed nor attached to any fixed structure said bag supporting a ballast weight and mechanically connected to a float located above it. The wave power converter further comprises a second airtight vessel communicating with said compressible bag via a tube furnished with power conversion means which converts a flow of gas into useful power transmitted to shore or used on board.
Feature 2) A wave power converter as described in feature 1 in which said power conversion means is a reversible flow air turbine generating useful power.
Feature 3) A wave power converter as described in features 1 or 2 in which the useful power is electricity.
Feature 4) A wave power converter as described in feature 1 in which the walls of said compressible bag are made of rubber, synthetic polymer or polymer coated fabric, reinforced with fibres, cables, strings or tendons made of any material.
Feature 5) A wave power converter as described in feature 1 in which said second airtight vessel comprises one or more elastic walls made of rubber or synthetic polymer with the effect that it is distensible.
Feature 6) A wave power converter comprising an elongate float connected to two compressible bags located below it, each furnished with ballast weights and power conversion means as described in features 1 or 2, said compressible bags communicating via a tube which allows gas to flow from one compressible bag to the other and to said second airtight vessel.
Feature 7) A wave power converter comprising four floats and four compressible bags furnished with ballast weights and power conversion means as described in features 1 or 2 communicating via tubes which allow gas to flow from one compressible bag to another and to said second airtight vessel.
Feature 8) A wave power converter as described in any of the above features further comprising a flexible or distensible bag entirely under water containing a variable quantity of water and mechanically attached to the float.
Feature 9) A wave power converter as described in any of the above features in which the float is made of airtight fabric inflated with gas under pressure and may be deflated in storms allowing the converter to sink until the ballast weights touch the sea bed, the converter being furnished with reflation means.
Feature 10) A wave power converter as described in feature 9 in which the reflation means is a pump aspirating air from the atmosphere through a snorkel or gas bottles carried on the float.

1. A wave power converter for generating electrical power from water waves; the wave power converter comprising:
an airtight compressible bag supporting a ballast and configured to be inflated with gas; the airtight compressible bag comprises flexible walls, wherein the shape and length of the bag is determined by the equilibrium between the weight of the ballast and the pressure inside the bag;
a floating body connected to the airtight compressible bag by a tube; and, an airtight vessel; and,
a power conversion means configured to generate power from the reciprocating flow of gas between said airtight compressible bag and said airtight vessel;
the wave power converter is configured such that, in use, the airtight compressible bag is totally submerged and surrounded by water on all sides wherein the heaving and/or pitching of said floating body in response to the waves excites the oscillation of said ballast which squeezes and expands said airtight compressible bag driving the contained gas via the tube and power conversion means into and out of the airtight vessel.

2. The wave power converter as claimed in claim 1, in which said airtight compressible bag is comprised of any one or more of: rubber sheet, synthetic polymer or polymer coated fabric, reinforced with fibres, cables, strings or tendons.

3. The wave power converter as claimed in claim 1, wherein the airtight compressible bag comprises a fabric and wherein the shape and vertical length of the bag is a function of the tension in the fabric and the gas pressure inside.

4. The wave power converter as claimed in claim 3, wherein the fabric of the bag is sufficiently flexible or elastic in the horizontal direction to stretch or fold as the bag expands and contracts.

5. The wave power converter as claimed in claim 1, wherein the airtight compressible bag is substantially axisymmetric about a vertical axis extending through opposite ends of the bag connecting the tube and ballast.

6. The wave power converter as claimed in claim 1, wherein the floating body comprises an elongate in plan shape.

7. The wave power converter as claimed in claim 6, wherein the airtight compressible bag is located about an off centre position along the elongate length of the floating body.

8. The wave power converter as claimed in claim 6, wherein the power conversion means comprises a housing suspended from an axle that is substantially horizontal and parallel to the elongate length of the float.

9. The wave power converter as claimed in claim 1, wherein the floating body comprises at least one or more float ballast containers located about one or both of the bow and stern of the floating body; the said containers configured to hold fluid.

10. The wave power converter as claimed in claim 9, wherein the floating body comprises a further float ballast container located about the centre of the elongate length, the wave power converter further comprising a pumping device configured to pump liquid to and from the centre container to at least one of the said one or more ballast containers.

11. The wave power converter as claimed in claim 1, wherein said power conversion means comprises a reversible flow air turbine.

12. The wave power converter as claimed in claim 1, wherein the said ballast is suspended from an end portion of the bag directly opposite the end of the bag connected to the said tube.

13. The wave power converter as claimed in claim 1, in which the airtight vessel comprises one or more elastic walls made of rubber or synthetic polymer with the effect that it is distensible.

14. The wave power converter as claimed in claim 1, comprising an elongate float connected to two compressible bags located below it, each furnished with ballast weights and separate power conversion means, said compressible bags communicating via a tube which allows gas to flow from one compressible bag to the other and to said airtight vessel.

15. The wave power converter as claimed in claim 1, comprising four of the said floating bodies and four of the said airtight compressible bags, each bag supporting a separate ballast and fluidly connected to a separate power conversion means as described in claim 1, the said bags communicating via tubes to allow gas to flow from one compressible bag to another and to said airtight vessel.

16. The wave power converter as claimed in claim 1, further comprising a flexible or distensible bag entirely under water containing a variable quantity of water and mechanically attached to the float.

17. The wave power converter as claimed in claim 1, in which the float comprises an airtight fabric inflated with gas under pressure and configured to be deflated to allow the converter to sink until the ballast weights touch the sea bed.

18. The wave power converter as claimed in claim 17, further comprising reflation means for inflating the float.

19. The wave power converter as claimed in claim 18 in which the reflation means comprises a pump aspirating air from the atmosphere through a snorkel or gas bottles carried on the float.

20. The wave power converter as claimed in claim 1, configured such that the tube connecting the airtight compressible bag to the floating body maintains a substantially vertical orientation when the floating body pitches and/or rolls.
